(19) United States
(12) Patent Application Publication
(10) Pub. No.: US 2023/0119056 A1
(43) Pub. Date: Apr. 20, 2023

(54) PARTIALLY METALLIZED GRATING AS HIGH-PERFORMANCE WAVEGUIDE INCOUPLER

(71) Applicant: Applied Materials, Inc., Santa Clara, CA (US)

(72) Inventors: Jianji YANG, Cupertino, CA (US); Samarth BHARGAVA, Saratoga, CA (US)

(21) Appl. No.: 17/954,100

(22) Filed: Sep. 27, 2022

Related U.S. Application Data
(60) Provisional application No. 63/256,261, filed on Oct. 15, 2021.

(51) Int. Cl. G02B 27/01; F21V 8/00

(52) U.S. Cl. CPC G02B 27/0172; G02B 6/0016; G02B 6/0038

(57) ABSTRACT

Embodiments of the present disclosure waveguides having device structures with a metallized portion and a method of forming the waveguide having device structures with the metallized portion are described herein. The plurality of device structures are formed having a device portion and a metallized portion. The metallized portion is disposed over at least a device portion surface of the device portion such that a plurality of gaps are disposed between the plurality of device structures.

### CROSS-REFERENCE TO RELATED APPLICATIONS

This application claims priority to U.S. Provisional Pat. Application Serial No. 63/256,261, filed on Oct. 15, 2021, which is herein incorporated by reference.

### FIELD

Embodiments of the present disclosure generally relate to optical devices for augmented, virtual, and mixed reality. More specifically, embodiments described herein provide for waveguides having device structures with a metallized portion and a method of forming the waveguide having device structures with the metallized portion.

### DESCRIPTION OF THE RELATED ART

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated to appear as part of the environment. Augmented reality can include any type of input, such as audio and haptic inputs, as well as virtual images, graphics, and video that enhance or augment the environment that the user experiences. As an emerging technology, there are many challenges and design constraints with augmented reality.

One such challenge is displaying a virtual image overlaid on an ambient environment. Optical devices including waveguide combiners, such as augmented reality waveguide combiners are used to assist in overlaying images. Generated light is propagated through an optical device until the light exits the optical device and is overlaid on the ambient environment. Optical devices include device structures disposed on a substrate. However, existing waveguides lack desired coupling efficiency. Accordingly, what is needed in the art are waveguides having improved coupling efficiency.

### SUMMARY

In one embodiment, a waveguide is provided. The waveguide includes a substrate and at least one grating disposed over the substrate. The at least one grating includes a plurality of device structures. Adjacent device structures of the plurality of device structures define a gap therebetween. The plurality of device structures include a device portion including a device material having a refractive index of about 1.3 to about 3.8 and a metallized portion disposed only on the device portion. The metallized portion includes a metallic material.

In another embodiment, a waveguide is provided. The waveguide includes a substrate and at least one grating disposed over the substrate. The at least one grating includes a plurality of device structures. Adjacent device structures of the plurality of device structures define a gap therebetween. The plurality of device structures include a device portion including a device material having a refractive index of about 1.3 to about 3.8 and a metallized portion that extends from an upper surface of the device portion to a first point or a second point. The metallized portion includes a metallic material. The first point is on a sidewall of the plurality of device structures. The first point is a first distance from a bottom surface of the substrate and the second point is spaced a second distance from the sidewall of the adjacent device structure of the plurality of device structures.

In yet another embodiment, an optical system is provided. The optical system includes a light source oriented over a first side of a waveguide. The waveguide includes at least one grating disposed over a second side of the waveguide opposite to the first side and the light source. The at least one grating includes a plurality of device structures. Adjacent device structures of the plurality of device structures define a gap therebetween. The plurality of device structures including a device portion including a device material having a refractive index of about 1.3 to about 3.8 and a metallized portion disposed only on an upper surface of the device portion. The metallized portion includes a metallic material.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic, top view of waveguide according to embodiments described herein.

FIGS. 2A-2C are schematic, cross-sectional views of a portion of a waveguide according to embodiments described herein.

FIGS. 3A-3C are schematic, top-views of a portion of a waveguide according to embodiments described herein.

FIG. 4 is a flow diagram of a method of forming a waveguide having device structures with a metallized portion according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices for augmented, virtual, and mixed reality. More specifically, embodiments described herein provide for waveguides having device structures with a metallized portion and a method of forming the waveguide having device structures with the metallized portion.

In one embodiment, the waveguide includes a substrate and at least one grating disposed over the substrate. The at least one grating includes a plurality of device structures. Adjacent device structures of the plurality of device structures define a gap therebetween. The plurality of device structures include a device portion including a device material having a refractive index of about 1.3 to about 3.8 and a metallized portion that extends from an upper surface of the device portion to a first point or a second point. The metallized portion includes a metallic material. The first point is on a sidewall of the plurality of device structures. The first point is a first distance from a bottom surface of the substrate and the second point is spaced a second distance from the sidewall of the adjacent device structure of the plurality of device structures.

In another embodiment, an optical system is provided. The optical system includes a light source oriented over a first side of a waveguide. The waveguide includes at least one grating disposed over a second side of the waveguide opposite to the first side and the light source. The at least one grating includes a plurality of device structures. Adjacent device structures of the plurality of device structures define a gap therebetween. The plurality of device structures including a device portion including a device material having a refractive index of about 1.3 to about 3.8 and a metallized portion disposed only on an upper surface of the device portion. The metallized portion includes a metallic material.

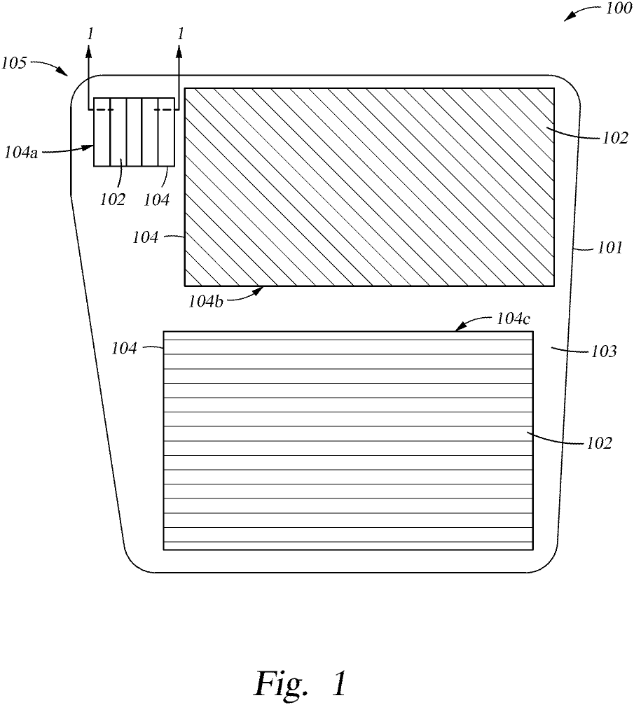

FIG. 1 is a schematic, top view of a waveguide 100. It is to be understood that the waveguide 100 described below is an exemplary optical device. In one embodiment, which can be combined with other embodiments described herein, the waveguide 100 is a waveguide combiner, such as an augmented reality waveguide combiner. The waveguide 100 may additionally be a waveguide utilized for optical sensing (e.g., eye tracking capabilities).

The waveguide 100 includes a plurality of device structures 102 disposed on a bottom surface 103 of a substrate 101. A portion 105 of the plurality of device structures 102 are shown in FIG. 1. The device structures 102 may be nanostructures having sub-micron dimensions, e.g., nano-sized dimensions. In one embodiment, which can be combined with other embodiments described herein, regions of the device structures 102 correspond to one or more gratings 104, such as a first grating 104A, a second grating 104B, and a third grating 104C. In one embodiment, which can be combined with other embodiments described herein, the waveguide 100 is a waveguide combiner that includes at least the first grating 104A corresponding to an input coupling grating and the third grating 104C corresponding to an output coupling grating. The waveguide combiner according to the embodiment, which can be combined with other embodiments described herein, includes the second grating 104B corresponding to an intermediate grating. The substrate 101 may be formed from any suitable material, provided that the substrate 101 can adequately transmit light in a desired wavelength or wavelength range and can serve as an adequate support for the waveguide 100, described herein. In one embodiment, which can be combined with other embodiments described herein, the wavelength range is between about 400 nm to about 2000 nm. For example, between about 400 nm to about 650 nm. Substrate selection may include substrates of any suitable material, including, but not limited to, silicon (Si), silicon dioxide (SiO₂), fused silica, quartz, silicon carbide (SiC), germanium (Ge), silicon germanium (SiGe), indium phosphide (InP), gallium arsenide (GaAs), diamond, gallium nitride (GaN), or sapphire containing materials.

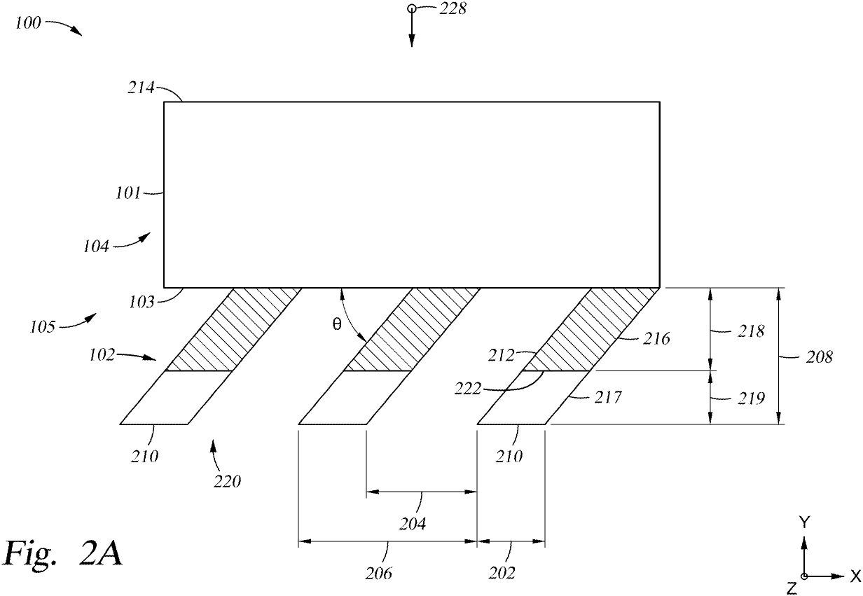

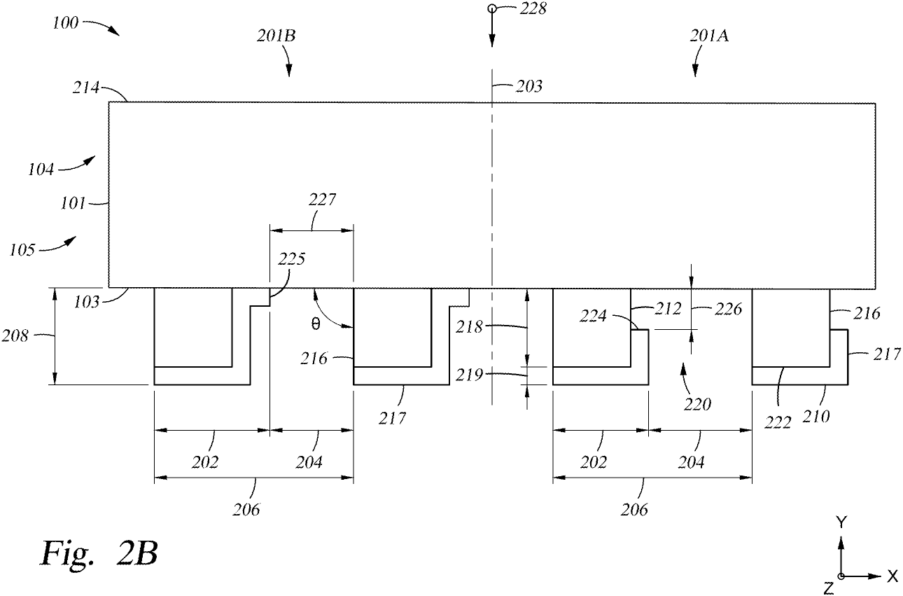

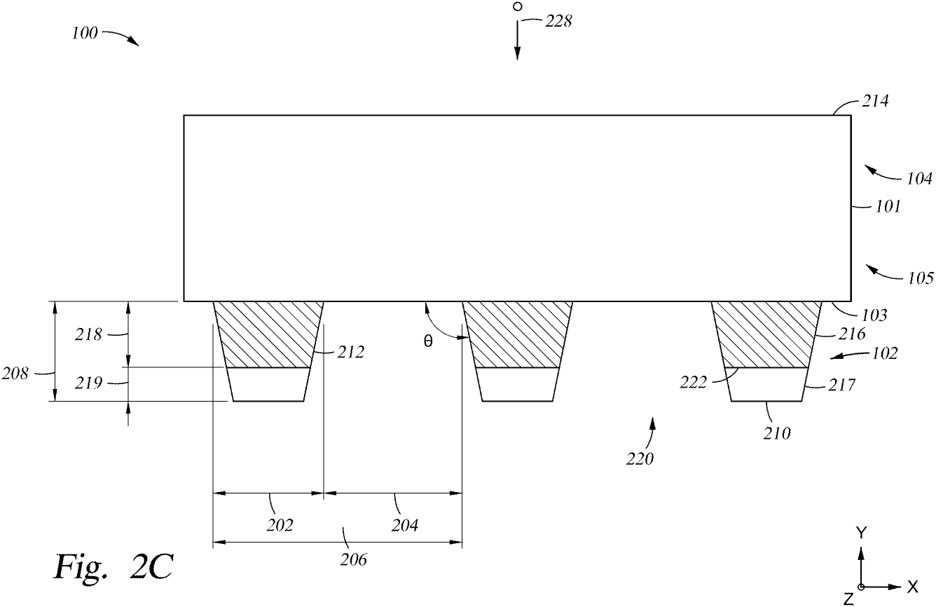

FIGS. 2A-2C are schematic, cross-sectional views of a portion 105 of a grating 104 of a waveguide 100. The grating 104 includes a plurality of device structures 102. FIGS. 2A-2C are taken along section line 1-1 of FIG. 1, such that the portion 105 of the grating 104 corresponds to a first grating 104a, e.g., an input coupling grating, of the waveguide 100. FIGS. 2A-2C depict the plurality of device structures 102 of the grating 104a. Although FIGS. 2A-2C shows the portion 105 corresponding to the first grating 104a, the portion 105 is not limited to the first grating 104a and may correspond to any of the first grating 104a, the second grating 104b, or the third grating 104c. The plurality of device structures 102 are disposed on a bottom surface 103 of a substrate 101. Each of the plurality of device structures 102 includes a device portion 216 and a metallized portion 217. The metallized portion includes a metallic upper surface 210. The device portion 216 includes a device portion upper surface 222. The plurality of device structures 102 define a plurality of gaps 220. Each gap of the plurality of gaps 220 is defined by the substrate 101 and adjacent device structures 102. The plurality of gaps 220 extend from the metallic upper surface 210 of the device structures 102 to the bottom surface 103 of the substrate 101. A height 208 of the plurality of device structures 102 is defined as the distance from the metallic upper surface 210 of each device structure 102 to the bottom surface 103 of the substrate 101. In one embodiment, which can be combined with other embodiments described herein, the height 208 is constant across the substrate 101. In another embodiment, which can be combined with other embodiments described herein, the height 208 varies across the substrate 101. The height 208 of each device structure 102 is between about 10 nm and about 2000 nm. For example, between about 10 nm and about 1 micron.

Each device structure 102 of the plurality of device structures 102 has a structure width 202. The structure width 202 is defined as the maximum width of the device structure 102 along the height 208. In one embodiment, which can be combined with other embodiments described herein, at least one structure width 202 may be different from another structure width 202. In another embodiment, which can be combined with other embodiments described herein, each structure width 202 of the plurality of device structures 102 is substantially equal to each other structure width 202. Each device structure 102 of the plurality of device structures 102 has a spacewidth 204. The spacewidth 204 is defined as the distance between each structure width 202 of adjacent device structures 102. In one embodiment, which can be combined with other embodiments described herein, at least one spacewidth 204 may be different from another spacewidth 204. In another embodiment, which can be combined with other embodiments described herein, each spacewidth 204 of the plurality of device structures 102 is substantially equal to each other spacewidth 204.

A pitch 206 is defined as the summation of the spacewidth 204 and the structure width 202 for each device structure 102. In one embodiment, which can be combined with other embodiments described herein, the pitch 206 is constant across the substrate 101. In another embodiment, which can be combined with other embodiments described herein, the pitch 206 varies across the substrate 101. The pitch 206 is between about 150 nm and about 1500 nm.

A duty cycle of the one or more gratings 104 of the waveguide 100 is defined as the ratio of the spacewidth 204 to the pitch 206. In one embodiment, which can be combined with other embodiments described herein, the duty cycle is constant across the substrate 101. In another embodiment, which can be combined with other embodiments described herein, the duty cycle varies across the substrate 101. The duty cycle is between about 5% and about 95%. For example, the duty cycle is between about 20% and about 80%.

The plurality of device structures 102 are formed at a device angle ϑ. The device angle ϑ is the angle between the surface 103 of the substrate 101 and a sidewall 212 of the device structure 102. As shown in FIGS. 2A and 2C, the plurality of device structures 102 are angled relative to the bottom surface 103 of the substrate 101. The device angle ϑ is between about 10 degrees and about 170 degrees, such as from about 40 degrees to about 140 degrees. For example, the device angle ϑ is from about 70 degrees to about 110 degrees. As shown in FIG. 2B, the plurality of device structures 102 are vertical, i.e., the device angle ϑ is 90 degrees. In one embodiment, which can be combined with other embodiments described herein, each respective device angle ϑ for each device structure 102 is substantially equal. In another embodiment, which can be combined with other embodiments described herein, at least one respective device angle ϑ of the plurality of device structures 102 is different than another device angle ϑ of the plurality of device structures 102.

One of one or more light sources 228, such as a display, may be positioned in a propagation direction of the waveguide 100. The one or more light sources 228 include, but are not limited to, a display (e.g., a microdisplay) and/or a light emitting device. The display includes, but is not limited to, a liquid crystal display (LCD) or any other display operable with the waveguide 100. The light emitting device includes, but is not limited to, a light-emitting diode (LED), a laser, a vertical-cavity surface-emitting laser (VCSEL), a non-VCSEL laser, or any emitter of light. The one or more light sources 228 are operable to project light (e.g., an image) to the waveguide 100. The light sources 228 transmit light at a wavelength or wavelength range. The wavelength range is between about 400 nm to about 2000 nm. For example, between about 400 nm to about 650 nm. The light source 228 is positioned above a top surface 214 of the substrate 101 such that the light source 228 directs light to an opposite side of the substrate 101 than the side the plurality of device structures 102 are disposed on or over, as shown in FIGS. 2A-2C. Therefore, the light is incident on the substrate 101 before the plurality of device structures 102.

The plurality of device structures 102 shown in FIGS. 2A-2C may correspond to any one of the first grating 104A, the second grating 104B, or the third grating 104C of the waveguide 100, shown in FIG. 1. The plurality of device structures 102 may be disposed on one or both the bottom surface 103 of the substrate 101 and the top surface 214 of the substrate 101. In the embodiments of the third grating 104C of the waveguide 100, the plurality of device structures 102 may be disposed on the same side of the waveguide 100 as the light source 228.

Each device portion 216 includes a device thickness 218. Each device portion 216 may have a different device thickness 218 or the same device thickness 218 as adjacent device portions 216. The device thickness 218 is between about 5 nm and about 1900 nm. For example, the device thickness is about 175 nm. Each metallized portion 217 includes a metal thickness 219. Each metallized portion 217 may have a different metal thickness 219 or the same metal thickness 219 as adjacent metallized portions 217. The metal thickness 219 is greater than about 1 nm. For example, the metal thickness 219 is greater than about 20 nm.

The metallized portion 217 includes a reflective metallic material. The metallic material includes, but is not limited to, a metal such as one of aluminum, silver, gold, platinum, or other metallic materials that can provide high reflectivity at the operating wavelengths, such as metal oxides. For example, the metal oxide is indium tin oxide (ITO). In one embodiment, which can be combined with other embodiments described herein, the device portion 216 is titanium oxide and the metallized portion 217 is aluminum. The metallized portion 217 reflects light and enhances the incoupling efficiency of the light that is coupled into the waveguide 100 toward the substrate 101. As such, the occurrence of back-diffraction and back-reflection of the light towards the light source 228 can be effectively lowered, thus reducing stray light and ghost imaging. For example, the one or more light sources 228 direct an image to the top surface 214 of the substrate 101 to the device structures 102 such that the metallized portion 217 directs the diffracted light through the waveguide 100. Increasing the metal thickness 219 will increase the reflectivity of the metallized portion and block more light from being back-diffracted towards the light source. The metallized portion 217 is disposed over at least the device portion upper surface 222 of the device portion 216. In some embodiments, the metallized portion 217 is only in contact with the device portion upper surface 222, as shown in FIGS. 2A and 2C.

FIG. 2B depicts a first configuration 201A and a second configuration 201B of the plurality of device structures 102. The first configuration is right of a dashed line 203 and a second configuration 201B of the plurality of device structures 102 is left of the dashed line 203. In some embodiments, the metallized portion 217 is in contact with the device portion upper surface 222 and the sidewall 212, as shown in the first configuration 201A and the second configuration 201B in FIG. 2B. As shown in the first configuration 201A, the metallized portion 217 extends from the device portion upper surface 222 to a first point 224 on the sidewall 212. The first point 224 is a first distance 226 from the bottom surface 103 of the substrate 101. The metallized portion 217 does not contact the bottom surface 103 of the substrate 101. As shown in the second configuration 201B, the metallized portion 217 extends from the device portion upper surface 222 to a second point 225 on the bottom surface 103 of the substrate 101. The second point 225 is spaced a second distance 227 from the sidewall 212 of the adjacent device structure 102. The second distance 227 is such that at least a portion of the substrate does not have the metallized portion 217.

The metallized portion 217 and the device portion 216 allows for the transmission of multiple wavelengths of light and/or multiple polarization directions through the waveguide 100, while allowing for the efficient coupling of an operating wavelength and an operating polarization i.e., the operating wavelength and operating polarization are not transmitted. Additionally, the metallized portion 217 and the device portion 216 allows for high efficiency incoupling of a wide range of incident angles of light, such that the field of view of the waveguide 100 can be enlarged. For example, the field of view is about -25 degrees to about 25 degrees.

The device portion 216 includes a device material. The refractive index of the device material of the device portion 216 is between about 1.3 to about 3.8. The device portion 216 includes, but is not limited to, device materials containing silicon, titanium oxide, niobium oxide, silicon nitride, hafnium oxide, tantalum oxide, scandium oxide, aluminum oxide, silicon oxide, silicon carbide, or combinations thereof. Increasing the refractive index of the material of the device portion 216 allows for a contrast between the air in the plurality of gaps 220 and the device portion 216. The contrast may improve the efficiency of the waveguide 100.

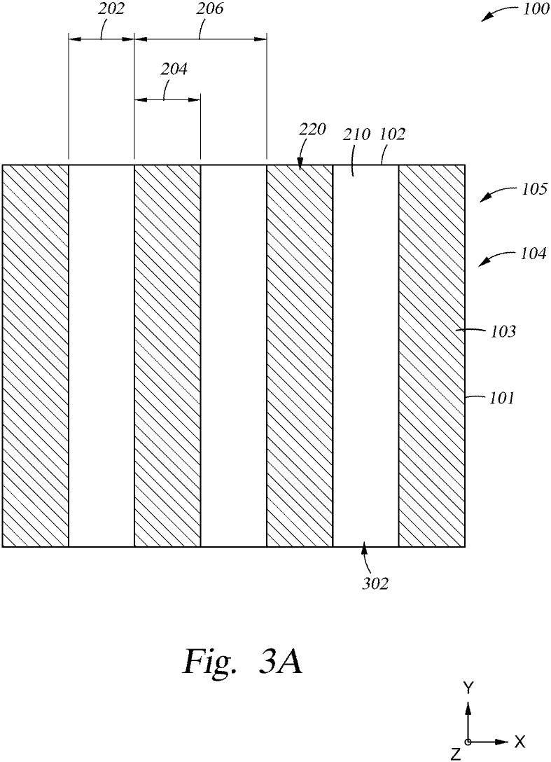

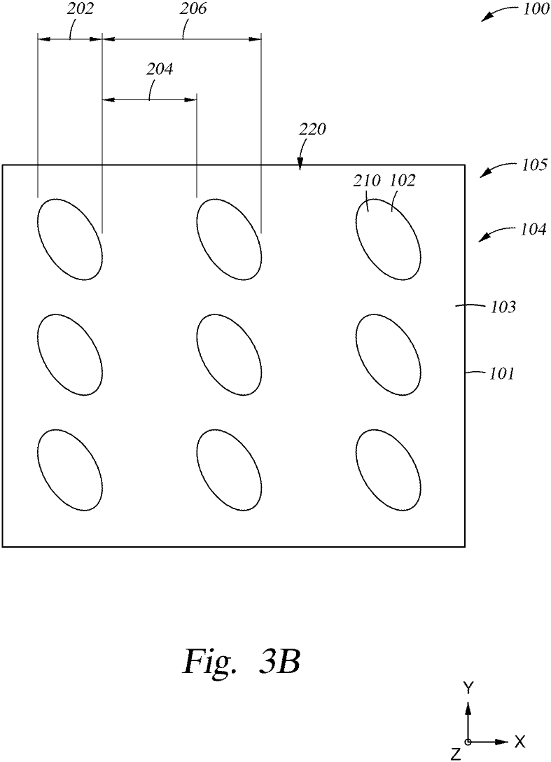

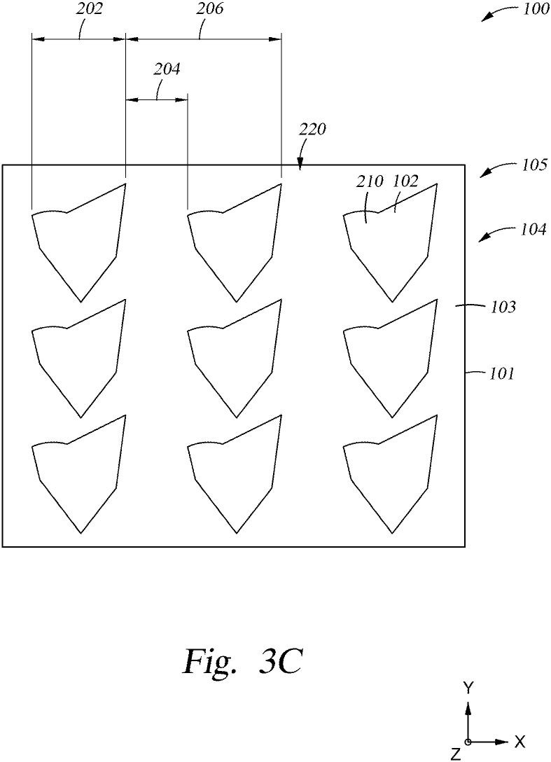

FIGS. 3A-3C are schematic, top-views of a portion 105 of a grating 104 of a waveguide 100. The grating 104 includes a plurality of device structures 102. The plurality of device structures 102 are disposed on a bottom surface 103 of a substrate 101. Each of the plurality of device structures 102 have a device portion 216 and a metallized portion 217 (shown in FIGS. 2A-2C).

As shown in FIG. 3A, the plurality of device structures 102 are fin structures. The fin structures are disposed in parallel rows 302. Although the plurality of device structures 102 in FIG. 3A depict a rectangular cross-section, the device structures 102 are not limited in the cross-section shape. As shown in FIG. 3B, the plurality of device structures 102 may be discrete device structures 102. Each device structure 102 is adjacent to other device structures 102 in both the first direction and the second direction, wherein the first direction is perpendicular to the second direction. For example, the plurality of device structures 102 are disposed along an x-direction and a y-direction, as illustrated in FIG. 3B, such that the plurality of device structures 102 are each disposed only along the first direction and the second direction. Although the plurality of device structures 102 in FIG. 3B depict an oval cross-section, the device structures 102 are not limited in the cross-section shape. As shown in FIG. 3C, the plurality of device structures 102 may be discrete device structures 102. Each device structure 102 is adjacent to other device structures 102 in both the first direction and the second direction, wherein the first direction is perpendicular to the second direction. The plurality of device structures 102 in FIG. 3C are not limited to the cross-section shown in FIG. 3C. For example, the cross-section of the plurality of device structures 102 may be any shape operable to support multiple layers of waveguides 100 formed thereon.

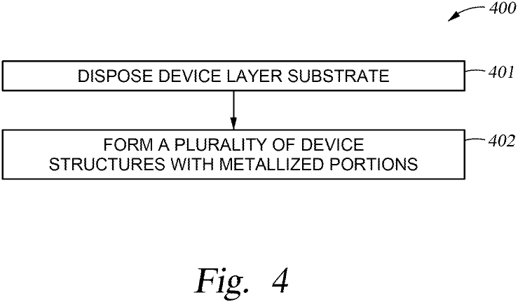

FIG. 4 is a flow diagram of a method of forming a waveguide 100 having device structures 102 with a metallized portion 217 according to embodiments described herein. To facilitate explanation, the method 400 is explained with reference to the plurality of device structures 102 shown in FIGS. 2A-2C, however it is contemplated that the method 400 may be performed to form any shaped device structure 102.

At operation 401, a device layer is disposed over a substrate 101. The device layer includes a device material. The device material is disposed using a liquid material pour casting process, a spin-on coating process, a liquid spray coating process, a dry powder coating process, a screen printing process, a doctor blading process, a PVD process, a CVD process, a FCVD process, a PECVD process, or an ALD process. The device material includes, but is not limited to, device materials containing silicon, titanium oxide, niobium oxide, silicon nitride, hafnium oxide, tantalum oxide, scandium oxide, aluminum oxide, silicon oxide, silicon carbide, or combinations thereof. The device layer is disposed over a bottom surface 103 of the substrate 101.

At operation 402, a plurality of device structures 102 are formed with a metallized portion 217. In one embodiment, which can be combined with other embodiments described herein, a metal layer is disposed over the device layer. The metal layer includes a metallic material. The metallic material includes, but is not limited to, a metal such as one of aluminum, silver, gold, platinum, or other metallic materials that can provide high reflectivity at the operating wavelengths, such as metal oxides. For example, the metal oxide is indium tin oxide (ITO). The metal layer is disposed using a liquid material pour casting process, a spin-on coating process, a liquid spray coating process, an ion beam sputtering process, a dry powder coating process, a screen printing process, a doctor blading process, a PVD process, an ion beam sputtering (IBS) process, a CVD process, a FCVD process, a PECVD process, or an ALD process. The plurality of device structures 102 are formed with one or more of a nanoimprint lithography, optical lithography, ion-beam etching, reactive ion etching, electron beam etching, or wet etching process, or combinations thereof.

In one embodiment, which can be combined with other embodiments described herein, the plurality of device structures 102 are formed such that each device structure 102 includes a device portion 216 corresponding to the device layer and a metallized portion 217 corresponding to the metal layer. In another embodiment, the device portion 216 is patterned from the substrate 101. For example, the substrate 101 may include a device material and the substrate 101 may be patterned to form the plurality of device structures 102 with the device portion 216, as shown in a second configuration 201B left of a dashed line 203 in FIG. 2B. The metallized portion 217 may be formed by disposing a metal layer over the substrate 101 and patterning the metal layer and the substrate 101 to form the plurality of device structures 102. Alternatively, the substrate 101 may be patterned and the metallized portion 217 formed after the patterning of the device portions 216.

In another embodiment, which can be combined with other embodiments described herein, the plurality of device structures 102 are formed with one or more of a nanoimprint lithography, optical lithography, ion-beam etching, reactive ion etching, electron beam etching, or wet etching process, or combinations thereof. In one embodiment, which can be combined with other embodiments described herein, the plurality of device structures 102 include a device portion 216 corresponding to the device layer. In another embodiment, which can be combined with other embodiments described herein, the plurality of device structures 102 are patterned from the substrate 101 to include a device portion 216 including the device material of the substrate 101. A plurality of gaps 220 are defined between the plurality of device structures 102. After the device portion 216 is formed, a metallic material is disposed with an angled deposition process over the device portion 216 to form a metallized portion 217. The angled deposition process includes, but is not limited to PVD, IBS, or combinations thereof. In some embodiments, he angled deposition process disposes the metallic material on at least the device portion upper surface 222 of the device portion 216.

The plurality of device structures 102 are formed such that the metallized portion 217 is at least disposed over a device portion upper surface 222 of the device portion 216 such that a plurality of gaps 220 are defined between the plurality of device structures 102, as shown in FIGS. 2A and 2C. As shown in the first configuration 201A, the metallized portion 217 extends from the device portion upper surface 222 to a first point 224 on the sidewall 212. The first point 224 is a first distance 226 from the bottom surface 103 of the substrate 101. The metallized portion 217 does not contact the bottom surface 103 of the substrate 101. As shown in the second configuration 201B, the metallized portion 217 extends from the device portion upper surface 222 to a second point 225 on the bottom surface 103 of the substrate 101. The second point 225 is spaced a second distance 227 from the sidewall 212 of the adjacent device structure 102. The second distance 227 is such that at least a portion of the substrate does not have the metallized portion 217.

In summation, waveguides having device structures with a metallized portion and a method of forming the waveguide having device structures with the metallized portion are described herein. The plurality of device structures are formed having a device portion and a metallized portion. The metallized portion is disposed over at least a device portion surface of the device portion such that a plurality of gaps are disposed between the plurality of device structures. The metallized portion disposed on the device portion upper surface allows for the transmission of multiple wavelengths of light and/or multiple polarization directions through the waveguide, while allowing for the efficient coupling of an operating wavelength and an operating polarization. The metallized portion is a reflective metallic material that reflects light and facilitates light to be coupled into the waveguide toward the substrate. As such, the occurrence of back-diffraction of the light towards a light source can be effectively lowered, thus reducing stray light and ghost imaging.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
a substrate; and
at least one grating disposed over the substrate, the at least one grating having a plurality of device structures, adjacent device structures of the plurality of device structures defining a gap therebetween, the plurality of device structures having:
a device portion, the device portion including a device material having a refractive index of about 1.3 to about 3.8; and
a metallized portion disposed only on the device portion, the metallized portion including a metallic material.

2. The waveguide of claim 1, wherein the metallized portion is disposed only on an upper surface of the device portion.

3. The waveguide of claim 1, wherein the metallized portion extends from an upper surface of the device portion to a first point on a sidewall of the plurality of device structures, the first point a first distance from a bottom surface of the substrate.

4. The waveguide of claim 1, wherein the metallized portion extends from an upper surface of the device portion to a second point on the substrate, the second point spaced a second distance from a sidewall of an adjacent device structure of the plurality of device structures.

5. The waveguide of claim 1, wherein the plurality of device structures are disposed with a device angle between about 10 degrees and about 170 degrees relative to a plane of the substrate.

6. The waveguide of claim 1, wherein the metallic material is a metal.

7. The waveguide of claim 1, wherein the metallic material is a metal oxide.

8. A waveguide, comprising:
a substrate; and
at least one grating disposed over the substrate, the at least one grating having a plurality of device structures, adjacent device structures of the plurality of device structures defining a gap therebetween, the plurality of device structures having:
a device portion, the device portion including a device material having a refractive index of about 1.3 to about 3.8; and
a metallized portion that extends from an upper surface of the device portion to a first point or a second point, the metallized portion including a metallic material, wherein;
the first point is on a sidewall of the plurality of device structures, the first point a first distance from a bottom surface of the substrate; and
the second point on the substrate, the second point spaced a second distance from the sidewall of the adjacent device structure of the plurality of device structures.

9. The waveguide of claim 8, wherein the plurality of device structures are disposed with a device angle between about 10 degrees and about 170 degrees relative to a plane of the substrate.

10. The waveguide of claim 8, wherein the metallic material includes at least one of aluminum, silver, gold, or platinum.

11. An optical system, comprising:
a light source oriented over a first side of a waveguide; and
the waveguide, the waveguide comprising:
at least one grating disposed over a second side of the waveguide opposite to the first side and the light source, the at least one grating having a plurality of device structures, adjacent device structures of the plurality of device structures defining a gap therebetween, the plurality of device structures having:
a device portion, the device portion including a device material having a refractive index of about 1.3 to about 3.8; and
a metallized portion disposed only on an upper surface of the device portion, the metallized portion including a metallic material.

12. The waveguide of claim 11, wherein the plurality of device structures are disposed with a device angle between about 10 degrees and about 170 degrees relative to a plane of the second side of the waveguide.

13. The waveguide of claim 11, wherein the metallized portion extends from an upper surface of the device portion to a first point on a sidewall of the plurality of device structures, the first point a first distance from a bottom surface of the substrate.

14. The waveguide of claim 11, wherein the metallized portion extends from an upper surface of the device portion to a second point on the substrate, the second point spaced a second distance from a sidewall of an adjacent device structure of the plurality of device structures.

16. The waveguide of claim 11, wherein the metallic material includes a metal.

17. The waveguide of claim 16, wherein the metal includes at least one of aluminum, silver, gold, or platinum.

18. The waveguide of claim 11, wherein the metallic material is a metal oxide.

19. The waveguide of claim 18, wherein the metal oxide is an indium tin oxide.

20. The waveguide of claim 11, wherein the metallized portion is disposed only on an upper surface of the device portion.
